(19) United States
(12) Patent Application Publication
(10) Pub. No.: US 2016/0026358 A1
(43) Pub. Date: Jan. 28, 2016

(54) GESTURE-BASED WINDOW MANAGEMENT

(71) Applicant: LENOVO (Singapore) PTE, LTD., New Tech Park (SG)

(72) Inventors: Aaron Michael Stewart, Raleigh, NC (US); Lance Warren Cassidy, Raleigh, NC (US); Jeffrey E. Skinner, Raleigh, NC (US); Jonathan Jen-Wei Yu, Raleigh, NC (US)

(21) Appl. No.: 14/444,771

(22) Filed: Jul. 28, 2014

(51) Int. Cl. G06F 3/0488; G06F 3/041; G06F 3/0482

(52) U.S. Cl. CPC G06F 3/0488; G06F 3/0482; G06F 3/041; G06F 2203/04104

(57) ABSTRACT

A method, apparatus, and computer program product are presented for detecting a multi-touch gesture on one or more displays of an information handling device, the information handling device being associated with a plurality of display contexts, and invoking a window event in response to the multi-touch gesture, the window event being associated with one or more graphical window interfaces presented within a display context of the plurality of display contexts.

### FIELD

The subject matter disclosed herein relates to gesture detection and more particularly relates to managing application windows based on gestures.

### BACKGROUND

### Description of the Related Art

In human-computer interaction, there may be multiple ways for a user to interact with a computer. For example, a user may use a mouse to move a cursor on a display, or a user may use a finger/stylus to interact with graphical items via a touch-enabled display. Additionally, the way in which a user interacts with a computer may depend on the particular operating system, the graphical user interface, or the like, that is being used on the computer.

Due to the multiple ways to interact with a computer interface, users may become confused about which interaction methods should be used for a particular computing system. In particular, with the advent of devices incorporating touch-enabled displays and gesture recognition, a user may not know which gestures can be used to interact with a computer, which gestures are recognizable by the computer, or the actions that gestures may perform on the computer.

### BRIEF SUMMARY

An apparatus for gesture-based window management is disclosed. A method and computer program product also perform the functions of the apparatus. An apparatus, in one embodiment, includes a processor, one or more displays comprising at least one multi-touch display, and memory that stores code executable by the processor. In certain embodiments, the apparatus includes code that detects a multi-touch gesture on the one or more displays. In some embodiments, the apparatus is associated with a plurality of display contexts.

In one embodiment, the apparatus includes code that invokes a window event in response to the multi-touch gesture. In some embodiments, the window event is associated with one or more graphical window interfaces presented within a display context of the plurality of display contexts. In one embodiment, the plurality of display contexts comprises a plurality of displays associated with the apparatus. In some embodiments, the plurality of display contexts comprises a plurality of display panes, which comprise a logically defined viewing area within a display associated with the apparatus.

The apparatus, in a further embodiment, includes code that assigns a multi-touch gesture to a window event associated with a display context of the plurality of display contexts. In one embodiment, the apparatus includes code that moves a graphical window interface from a first display context associated with the apparatus to a second display context associated with the apparatus in response to the multi-touch gesture. In such an embodiment, the window event comprises a repositioning event. In certain embodiments, the graphical window is moved in a direction that corresponds to the direction of the multi-touch gesture. In a further embodiment, the graphical window is moved a distance proportional to a length of the multi-touch gesture.

In some embodiments, the apparatus includes code that reveals a graphical window interface on a display associated with the apparatus in response to the multi-touch gesture. In such an embodiment, the window event comprises a revealing event. In a further embodiment, the graphical window interface is revealed from an edge of a display associated with the apparatus. In certain embodiments, an amount of the graphical window interface that is revealed from the edge of the display is based on a length of a multi-touch gesture. In one embodiment, the revealed graphical window interface comprises an input interface, which includes one of an on-screen keyboard and a note-taking application.

In one embodiment, the apparatus includes code that changes a view of contents presented within a graphical window interface in response to the multi-touch gesture. In such an embodiment, the window event comprises a view event. In a further embodiment, the multi-touch gesture is one of a plurality of multi-touch gestures comprising a gesture library. In one embodiment, each multi-touch gesture of the plurality of multi-touch gestures is assigned to a unique window event.

A method is disclosed that includes detecting, by use of a processor, a multi-touch gesture on an information handling device. In one embodiment, the information handling device is associated with a plurality of display contexts. In a further embodiment, the method includes invoking a window event in response to the multi-touch gesture. In one embodiment, the window event is associated with one or more graphical window interfaces presented within a display context of the plurality of display contexts.

In one embodiment, the plurality of display contexts includes a plurality of display associated with the information handling device or a plurality of display panes, which comprise a logically define viewing area within a display associated with the information handling device. In some embodiments, the method includes assigning a multi-touch gesture to a window event associated with a display context of the plurality of display contexts. In certain embodiments, the window event comprises a repositioning event that moves a graphical window interface from a first display context associated with the information handling device to a second display context associated with the information handling device in response to the multi-touch gesture.

In one embodiment, the window event comprises a revealing event that reveals a graphical window interface on a display context associated with the information handling device in response to the multi-touch gesture. In some embodiments, the graphical window interface is revealed from an edge of a display context associated with the information handling device. In some embodiments, the window event comprises a view event that changes a view of contents presented within a graphical window interface in response to the multi-touch gesture.

A program product is disclosed that includes a computer readable storage medium that stores code executable by a processor. In one embodiment, the executable code comprises code to perform detecting a multi-touch gesture on an information handling device. In one embodiment, the information handling device is associated with a plurality of display contexts. The executable code, in certain embodiments, includes code to perform invoking a window event in response to the multi-touch gesture. In one embodiment, the window event is associated with one or more graphical window interfaces presented within a display context of the plurality of display contexts.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a system for gesture-based window management;

FIG. 2 is a schematic block diagram illustrating one embodiment of an information handling device including a window management module;

FIG. 3 is a schematic block diagram illustrating one embodiment of a window management module;

FIG. 4 is a schematic block diagram illustrating another embodiment of a window management module;

FIG. 5 illustrates one embodiment of a gesture-based window event;

FIG. 6 illustrates another embodiment of a gesture-based window event;

FIG. 7 illustrates yet another embodiment of a gesture-based window event; and

FIG. 8 is a schematic flow chart diagram illustrating one embodiment of a method for gesture-based window management.

### DETAILED DESCRIPTION

As will be appreciated by one skilled in the art, aspects of the embodiments may be embodied as a system, method or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, comprise one or more physical or logical blocks of executable code which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. These code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which comprises one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

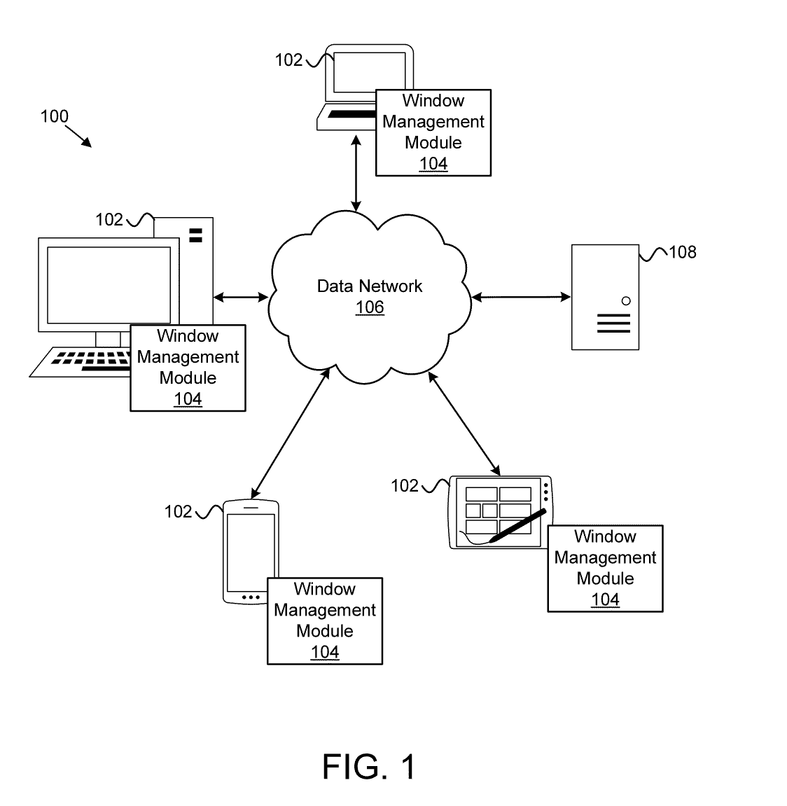

FIG. 1 depicts one embodiment of a system 100 for gesture-based window management. In one embodiment, the system 100 includes information handling devices 102, window management modules 104, data networks 106, and servers 108, which are described below in more detail. While a specific number of elements 102-108 are depicted in FIG. 1, any number of elements 102-108 may be included in the system 100 for gesture-based window management.

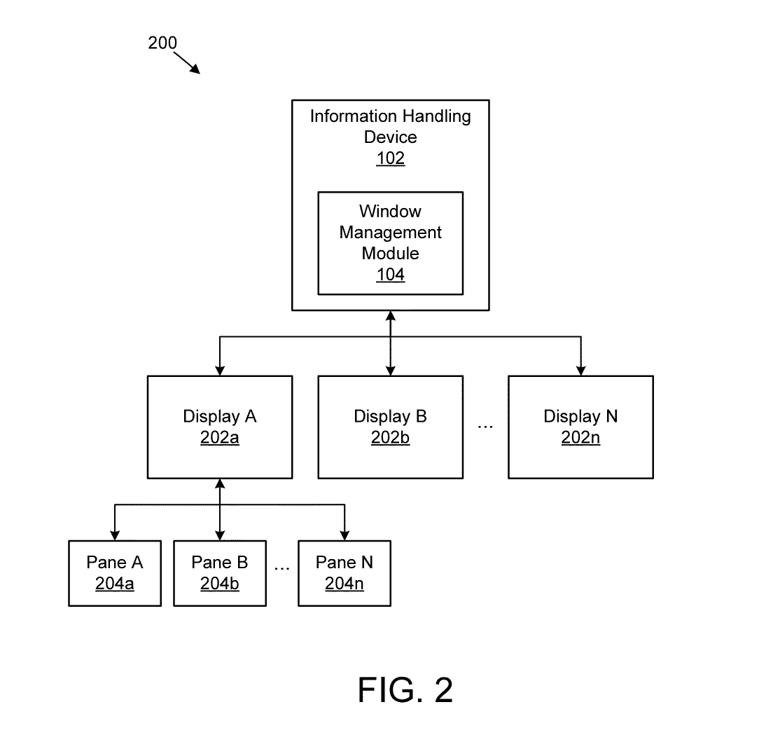

In one embodiment, the information handling devices 102 include electronic computing devices, such as desktop computers, laptop computers, tablet computers, smart televisions, smart phones, servers, and/or the like. The information handling devices 102, in certain embodiments, are associated with one or more electronic displays, such as monitors, televisions, touch screen displays, or the like. In some embodiments, a display may include multiple display panes that logically divide the display into a plurality of viewing areas. The information handling devices 102 and their associated displays are described in more detail below with reference to FIG. 2.

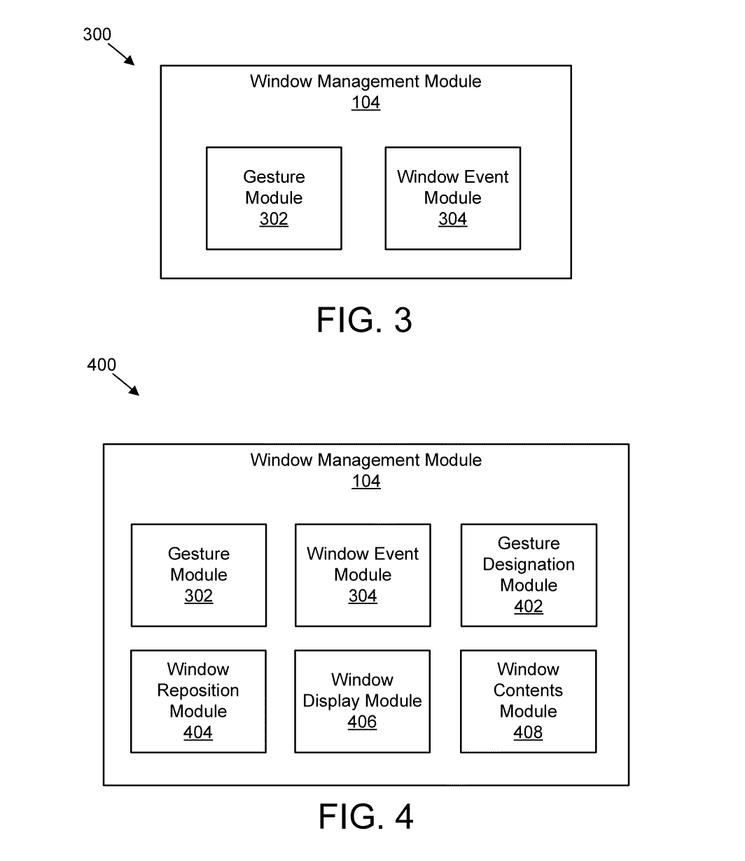

In one embodiment, the window management module 104, in general, is configured to detect a multi-touch gesture on one or more displays associated with an information handling device 102 and invoke a window event in response to the multi-touch gesture. The window management module 104 may include a plurality of modules that perform the operations of the window management module 104. In certain embodiments, at least a portion of the window management module 104 is located on an information handling device 102, on a display associated with the information handling device 102, or both. The window management module 104 is discussed in more detail below with reference to FIGS. 3 and 4.

The data network 106, in one embodiment, comprises a digital communication network that transmits digital communications. The data network 106 may include a wireless network, such as a wireless cellular network, a local wireless network, such as a Wi-Fi network, a Bluetooth® network, a near-field communication (NFC) network, an ad hoc network, and/or the like. The data network 106 may include a wide area network (WAN), a storage area network (SAN), a local area network (LAN), an optical fiber network, the internet, or other digital communication network. The data network 106 may include two or more networks. The data network 106 may include one or more servers, routers, switches, and/or other networking equipment. The data network 106 may also include computer readable storage media, such as a hard disk drive, an optical drive, non-volatile memory, random access memory (RAM), or the like.

In one embodiment, the system 100 includes a server 108. The server 108 may be embodied as a desktop computer, a laptop computer, a mainframe, a cloud server, a virtual machine, or the like. In some embodiments, the information handling devices 102 are communicatively coupled to the server 108 through the data network 106. In some embodiments, the server 108 may store data related to gesture-based window management, such as a gesture library, predefined gestures, gesture signatures, and/or the like.

FIG. 2 depicts one embodiment 200 of an information handling device 102 that includes a window management module 104. In one embodiment, the information handling device 102 is associated with one or more displays 202a-n, wherein at least of the displays 202a-n comprises a multi-touch display. In some embodiments, the displays 202a-n present one or more application windows. As used herein, an application window is a graphical control element that consists of a visual area containing graphical user interfaces of the program it belongs to and may be framed by a window decoration. An application window may have a rectangular shape and may overlap other windows. A window may also display output for a program and receive input for one or more processes. In certain embodiments, an information handling device 102 includes an integrated display 202a-n, such as an integrated display for a laptop, a smart phone, or a tablet computer. In some embodiments, the information handling device 102 is operably connected to one or more displays 202a-n. For example, the information handling device 102 may be connected to a display 202a-n via a wired connection, such as an HDMI, VGA, DVI, or the like connection.

The information handling device 102, in some embodiments, may be wirelessly connected to a display 202a-n. For example, the information handling device 102 may send display data to a display 202a-n via the data network 106. The display 202a-n, in such an embodiment, may include networking hardware to connect to the data network 106 (e.g., a smart television) or may be connected to a media device (e.g., a game console, a set-top box, a DVR, or the like) that is connected to data network 106. In certain embodiments, the display 202a-n includes a touch screen display that receives input from a user in response to a user interacting with the touch screen, such as by using one or more fingers or a stylus.

In one embodiment, the viewing area of a display 202a-n may be divided into a plurality of display panes 204a-n. As used herein, a display pane 204a-n is a logically defined viewing area of the display 202a-n that presents one or more application windows. For example, a laptop display may be divided into two display panes 204a-n, with each pane 204a-n containing separate application windows. In such an embodiment, the application windows may be moved between the different display panes 204a-n. In certain embodiments, the window management module 104 coordinates and manages the organization, display, alignment, location, size, movement, or the like, of the application windows. In certain embodiments, the plurality of displays 202a-n, the plurality of display panes 204a-n, or a combination of both, comprise a plurality of display contexts associated with the information handling device 102.

FIG. 3 depicts one embodiment of a module 300 for window management. In one embodiment, the module 300 includes an embodiment of a window management module 104. The window management module 104, in certain embodiments, includes a gesture module 302 and a window event module 304, which are described in more detail below.

The gesture module 302, in certain embodiments, is configured to detect a multi-touch gesture on one or more displays 202a-n associated with an information handling device 102. Detecting a multi-touch gesture, as used herein, refers to the ability of a multi-touch display 202a-n to recognize the presence of a plurality of contact points within the surface of the display 202a-n. For example, the gesture module 302 may detect a user touching the display 202a-n with three or four fingers, or other objects, simultaneously. In some embodiments, the multi-touch gesture includes a swipe gesture, a tap gesture, a tap-and-hold gesture, a drag gesture, and/or the like.

In certain embodiments, a multi-touch gesture is associated with a window event. For example, a three-finger tap-and-hold gesture may initiate a window move event such that the user may move an application window presented on a display in response to moving the three fingers. In certain embodiments, the gesture module 302 maintains a library of multi-touch gestures, with each gesture being assigned or associated with a unique window event. For example, a three-finger tap-and-hold gesture may initiate a window move event, a four-finger swipe gesture from the edge of a display may reveal virtual input devices, or the like. In certain embodiments, the gesture module 302 adds new multi-touch gestures, modifies existing multi-touch gestures, or removes multi-touch gestures from the library in response to user input. For example, a user may assign a new gesture to a window event, reassign a gesture to a different window event, or remove an association between a gesture and a window event.

The gesture library, in certain embodiments, may contain predefined assignments of multi-touch gestures to window events, which may not be modified, added to, or removed from. In such an embodiment, the gesture library may be configured as a standardized multi-touch gesture library that may be included on a variety of different information handling devices 102 so that users of different information handling devices 102 expect the same multi-touch gestures to perform the same window events. For example, a user using a touch-enabled laptop and a tablet computer, which each have the same standard gesture library installed, may use the same three-finger tap-and-drag gesture to move a window presented on the display. In this manner, the user does not need to relearn new multi-touch gestures, and their accompanying window events, in order to manage presented windows.

In one embodiment, the multi-touch gestures and the window events are defined by the type of operating system running on the information handling device 102. For example, operating system A may not recognize four-finger gestures and operating system B may not allow windows to be revealed from the edge of the display in response to a multi-touch gesture.

The window event module 304, in one embodiment, invokes a window event in response to the multi-touch gesture detected by the gesture module 302. As used herein, a window event may be associated with one or more graphical window interfaces that are presented within a display context of a plurality of display contexts associated with the information handling device 102. For example, a graphical window interface may be displayed on at least one of a plurality of displays 202a-n or a plurality of display panes 204a-n associated with the information handling device 102. A window event may include changing a location of a window on the display, hiding a window, revealing a window, moving a window, closing a window, opening a window, and/or the like. In certain embodiments, as described in FIG. 4, the window event module 304 uses one or more different modules to perform various window events, such as the window reposition module 404, the window display module 406, and the window contents module 408.

The window event module 304 may invoke a window event that has been assigned to the detected multi-touch gesture in response to the multi-touch gesture. For example, the window event module 304 may reveal a new window from the edge of a display 202a-n in response to a four-finger swipe gesture. In another example, the window event module 304 may move a window to a new location in response to a three-finger tap-and-drag gesture.

FIG. 4 depicts one embodiment of a module 400 for gesture-based window management. In one embodiment, the module 400 includes one embodiment of a window management module 104. The window management module 104, in certain embodiments, includes a gesture module 302 and a window event module 304, which may be substantially similar to the gesture module 302 and the window event module 304 described above with reference to FIG. 3. In certain embodiments, the window management module 104 includes a gesture designation module 402, a window reposition module 404, a window display module 406, and a window contents module 408, which are described in more detail below.

In one embodiment, the gesture designation module 402 assigns a multi-touch gesture to a window event associated with a display context of the plurality of display contexts. In certain embodiments, the gesture designation module 402 assigns a multi-touch gesture to a window event in response to user input. For example, a user may assign a three-finger swipe gesture to a window move event such that performing the three-finger swipe gesture within an active application window will move the window to a new location. One of skill in the art will recognize the various combinations of multi-touch gestures that may be assigned to window events.

In some embodiments, the gesture designation module 402 assigns a multi-touch gesture to a window event based on a predetermined assignment schedule. For example, in order to standardize the assignment of multi-touch gestures to window events across different platforms, the gesture designation module 402 may assign multi-touch gestures to window events according to a predetermined, predefined, standard, or default gesture assignment schedule, list, or the like. In certain embodiments, the gesture designation module 402 uses the gesture library as a basis for the assignments of multi-touch gestures to window events. The gesture designation module 402, in one embodiment, changes or modifies the predetermined multi-touch gesture assignments in response to user input.

In one embodiment, the window reposition module 404 moves a graphical window interface from a first display context, i.e., from a first display 202a-n, or from a first display pane 204a-n within a display 202a-n, associated with the information handling device 102 to a second display context, i.e., to a second display 202a-n, or to a second display pane 204a-n within a display 202a-n, associated with the information handling device 102 in response to an assigned multi-touch gesture. The multi-touch gesture may include a multi-touch tag-and-drag gesture, a multi-touch swipe gesture, or the like gesture, which may be the standard multi-touch gesture for moving windows between multiple displays 202a-n or display panes 204a-n.

In some embodiments, the window reposition module 404 may detect the multi-touch gesture being performed at any location within the active window. For example, a user may perform the gesture in the middle of the active window, instead of in a specific, predetermined, designated location for moving windows, such as the title bar for the window. In some embodiments, the window reposition module 404 moves a window in response to a multi-touch gesture being performed at a predetermined or designated location on the window, such as the title bar. In certain embodiments, the window is moved in a direction that corresponds to the direction of the multi-touch gesture. In some embodiments, the window is moved a distance proportional to a length of the multi-touch gesture. For example, a three-finger swipe gesture that is performed from a right side of display 202a-n and goes halfway across the display 202a-n will move the window that is the subject of the repositioning event halfway across the display 202a-n in the same direction as the swipe gesture.

In one embodiment, the window display module 406 reveals a graphical window interface on a display context associated with the information handling device 102 in response to a multi-touch gesture. For example, a four-finger tap gesture may reveal all hidden or minimized windows. In certain embodiments, a graphical window interface is revealed from an edge of a display context associated with the information handling device 102. For example, the window display module 406 may detect a three-finger swipe gesture starting at the bottom edge of the display context, i.e., the bottom edge of a display 202a-n or display pane 204a-n, and moving towards the top of the display context. In such an embodiment, the window display module 406 may reveal an application window from the edge of the display context in response to the multi-touch gesture. In certain embodiments, the amount of the graphical window interface that is revealed from the edge of the display context is based on one or more characteristics of the multi-touch gesture, such as a length of a multi-touch swipe gesture, an amount of time a tap-and-hold gesture is held down, or the like. The application window that is displayed by the window display module 406 may include an input window, such as a virtual keyboard, virtual notepad, virtual track pad, or the like.

In certain embodiments, the window display module 406 may reveal a specific application window in response to a specific multi-touch gesture. For example, the window display module 406 may display an Internet browser in response to a four-finger tap gesture. In some embodiments, the window display module 406 reveals an application window in response to a multi-touch gesture being performed at a predetermined location on the display context. For example, the window display module 406 may reveal a virtual keyboard in response to a four-finger tap gesture performed in an upper-right corner of a display 202a-n and a window for an email application in response to a four-finger tap gesture performed in a lower left corner of the display 202a-n.

In one embodiment, the window contents module 408 changes a view of contents presented within a graphical window interface in response to a multi-touch gesture. In certain embodiments, if an application comprises multiple modes, views, or the like, the window contents module 408 changes the view or the viewable contents of the window in response to the multi-touch gesture. For example, a virtual keyboard application may include multiple keyboard layouts, languages, or other input methods, and the window contents module 408 may change the keyboard layout, language, or input method in response to a four-finger left or right swipe gesture. In certain embodiments, the window contents module 408 presents a shortcut menu, list, or thumbnail view of alternative views for the application in response to a multi-touch gesture, such as a four-finger tap-and-hold gesture.

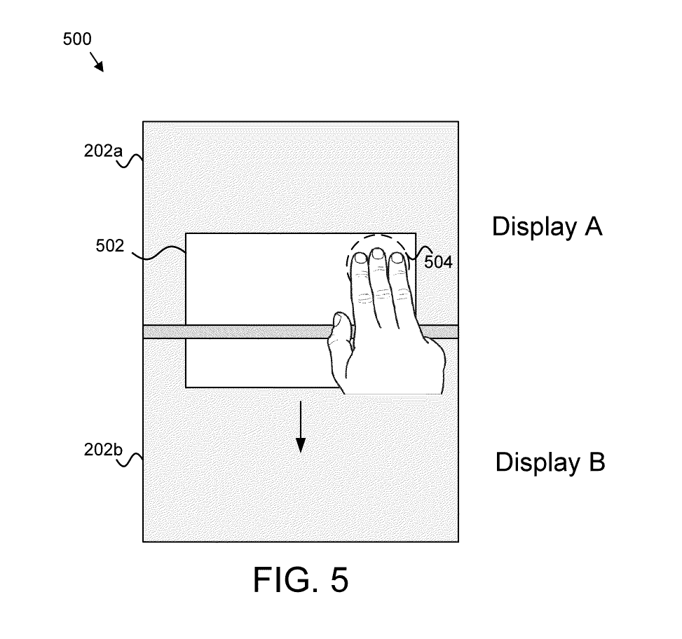

FIG. 5 illustrates one embodiment of a gesture-based window event 500. In one embodiment, the gesture-based window event 500 includes a first display 202a and a second display 202b. In certain embodiments, the displays 202a-b may be embodied as display panes 204a-n of a single display 202a-n. In one embodiment, a gesture module 302 detects a multi-touch gesture 504 performed on the first display 202a. As shown in FIG. 5, the multi-touch gesture may comprise a three-finger tap-and-drag gesture 504 in order to move the application window 502 from the first display 202a to the second display 202b.

The window event module 304, in response to the detection of the multi-touch gesture 504, may invoke a window event assigned to the particular multi-touch gesture 504. In the depicted embodiment, the window event may include a window move event. The window event module 304 may invoke the window reposition module 404 in order to move the window 502 to the location specified by the user. The window reposition module 404, in certain embodiments, may be invoked by the window event module 304 in response to a multi-touch gesture 504 assigned to a window move event being performed anywhere within the window 502. Thus, even though a three-finger tap-and-drag gesture 504 is depicted, any type of multi-touch gesture may be assigned to a window move event.

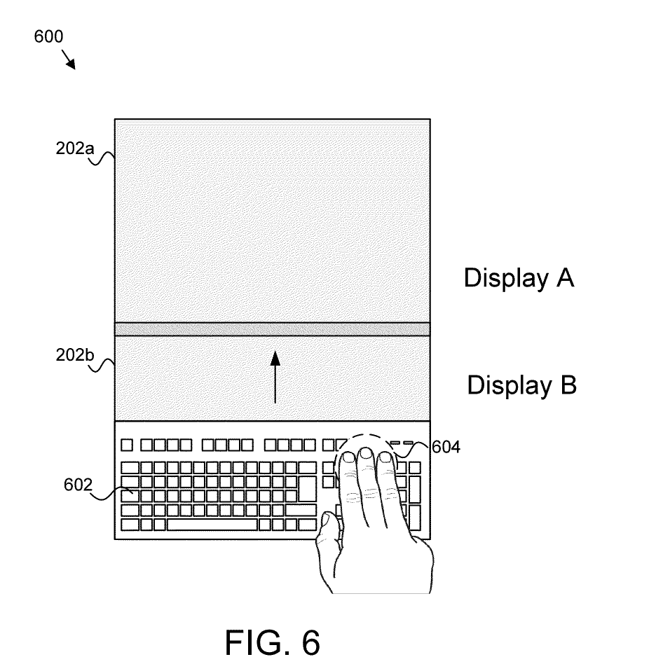

FIG. 6 illustrates another embodiment of a gesture-based window event 600. In one embodiment, the gesture-based window event 600 includes a first display 202a and a second display 202b. In certain embodiments, the displays 202a-b may be embodied as display panes 204a-n of a single display 202a-n. In one embodiment, a gesture module 302 detects a multi-touch gesture 604 performed on the edge of the second display 202b. As shown in FIG. 6, the multi-touch gesture may comprise a three-finger swipe gesture 604 in order to reveal the application window 602 from the bottom edge of the display 202b.

The window event module 304, in response to the detection of the multi-touch gesture 604, may invoke a window event assigned to the particular multi-touch gesture 604. In the depicted embodiment, the window event may include a window reveal event. The window event module 304 may invoke the window display module 406 in order to reveal the window 602 from the bottom edge of the display 202b. The window display module 406, in certain embodiments, may be invoked by the window event module 304 in response to a multi-touch gesture 604 assigned to a window reveal event. Thus, even though a three-finger swipe gesture 604 is depicted, any type of multi-touch gesture may be assigned to a window reveal event. In certain embodiments, the application window 602 comprises an input window, such as a virtual keyboard, a virtual touch pad, a virtual note taking application, or the like. In certain embodiments, the amount of the window 602 that is revealed is based on a characteristic of the gesture 604, such as a length of a swiping gesture, an amount of time a tap-and-hold gesture is held down, or the like.

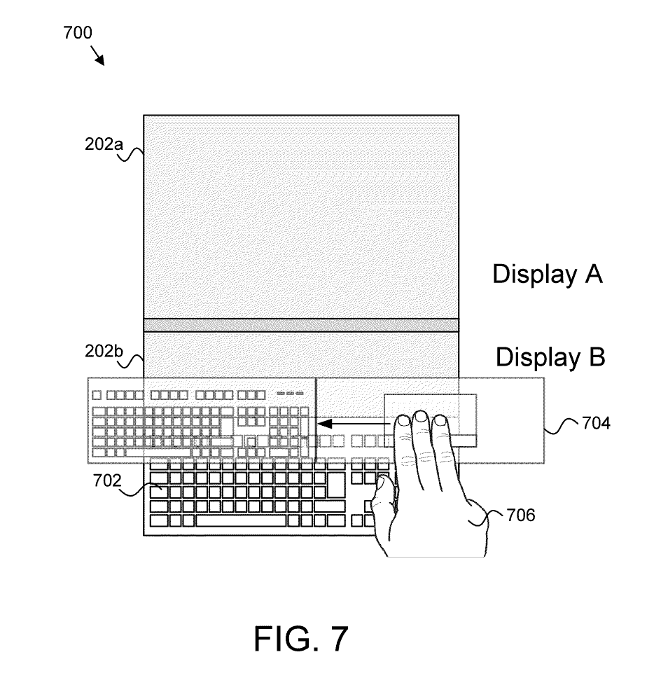

FIG. 7 illustrates one embodiment of a gesture-based window event 700. In one embodiment, the gesture-based window event 700 includes a first display 202a and a second display 202b. In certain embodiments, the displays 202a-b may be embodied as display panes 204a-n of a single display 202a-n. In one embodiment, a gesture module 302 detects a multi-touch gesture 706 performed on the second display 202b within an application window 702. In certain embodiments, the application window 702 comprises the active application window 702, i.e., the application window 702 that has focus. As shown in FIG. 7, the multi-touch gesture may comprise a three-finger left swipe gesture 706 within the window 702.

The window event module 304, in response to the detection of the multi-touch gesture 706, may invoke a window event assigned to the particular multi-touch gesture 706. In the depicted embodiment, the window event may include changing the view, mode, or contents of the window 702. The window event module 304 may invoke the window contents module 408 in order to change the view of the window 702. For example, as depicted in FIG. 7, the window contents module 408 may change the contents of the window 702 from a virtual keyboard to a virtual touchscreen. The window contents module 408, in certain embodiments, may display an overlay 704 of different window views for the window 702 in response to the multi-touch gesture 706. After the overlay 704 is presented, the user may select a view from various view options displayed in the overlay 704. The window contents module 408, in certain embodiments, may be invoked by the window event module 304 in response to a multi-touch gesture 706 assigned to a window event that changes the contents of the window. Thus, even though a three-finger swipe gesture 706 is depicted, any type of multi-touch gesture may be assigned to a window move event.

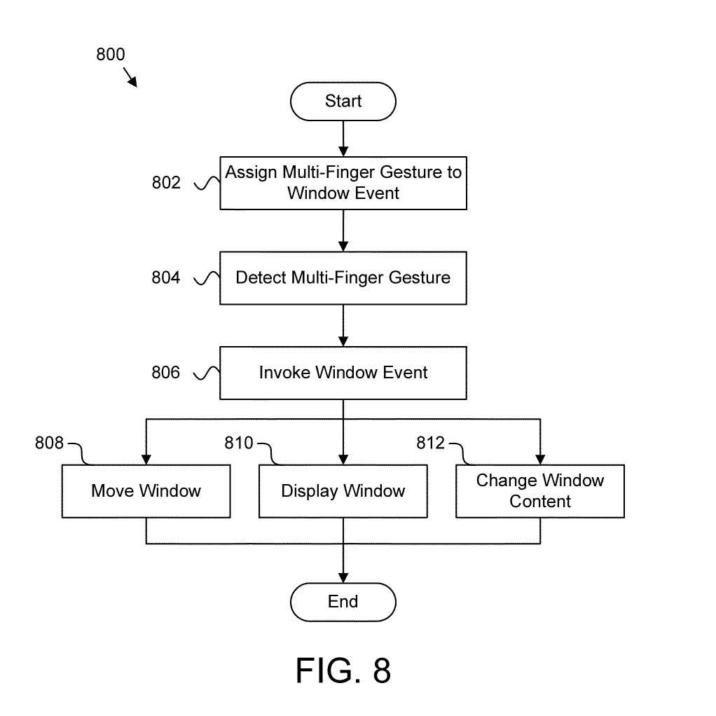

FIG. 8 is a schematic flow chart diagram illustrating one embodiment of a method 800 for gesture-based window management. In one embodiment, the method 800 begins and a gesture designation module 402 assigns 802 a multi-touch gesture to a window event. For example, a three-finger tap-and-drag gesture may be assigned to a window move event, a four-finger swipe gesture performed on an edge of a display 202a-n may invoke a window reveal event, or the like. A gesture module 302 detects 804 a multi-touch gesture on one or more displays 202a-n, which may include at least one multi-touch display 202a-n, and a window event module 304 invokes a window event in response to the multi-touch gesture.

In certain embodiments, the window event module 304 invokes 806 a window event based on the type of multi-touch gesture performed, the location on the display 202a-n where the multi-touch gesture is performed, one or more characteristics of the multi-touch gesture, or the like. For example, a window reposition module 404 may move 808 the window to a new location in response to a three-finger tap-and-drag gesture. In another example, the window display module 406 may display 810 a hidden window in response to a four-finger swipe gesture. The window may comprise an input window, such as a virtual keyboard, touch pad, or note pad, which is revealed from an edge of a display 202a-n in response to the multi-touch gesture. In a further example, the window display module 406 may change 812 a window's contents or views in response to a four-finger left or right swipe gesture performed within a window associated with an application that comprises multiple modes, views, contents, or the like. Thus, a four-finger left swipe performed within a virtual keyboard window may alter the layout of the virtual keyboard. Alternatively, a four-finger tap-and-hold may display an overlay that presents a list of views, a list of thumbnails, or the like, which the user may use to select a particular view for the window, and the method 800 ends.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus comprising:
a processor;
one or more displays comprising at least one multi-touch display;
a memory that stores code executable by the processor, the code comprising:
code that detects a multi-touch gesture on the one or more displays, the apparatus being associated with a plurality of display contexts; and
code that invokes a window event in response to the multi-touch gesture, the window event being associated with one or more graphical window interfaces presented within a display context of the plurality of display contexts.

2. The apparatus of claim 1, wherein the plurality of display contexts comprises a plurality of displays associated with the apparatus.

3. The apparatus of claim 1, wherein the plurality of display contexts comprises a plurality of display panes, a display pane comprising a logically defined viewing area within a display associated with the apparatus.

4. The apparatus of claim 1, further comprising code that assigns a multi-touch gesture to a window event associated with a display context of the plurality of display contexts.

5. The apparatus of claim 1, further comprising code that moves a graphical window interface from a first display context associated with the apparatus to a second display context associated with the apparatus in response to the multi-touch gesture, the window event comprising a repositioning event.

6. The apparatus of claim 5, wherein the graphical window is moved in a direction that corresponds to the direction of the multi-touch gesture, and wherein the graphical window is moved a distance proportional to a length of the multi-touch gesture.

7. The apparatus of claim 1, further comprising code that reveals a graphical window interface on a display context associated with the apparatus in response to the multi-touch gesture, the window event comprising a revealing event.

8. The apparatus of claim 7, wherein the graphical window interface is revealed from an edge of a display context associated with the apparatus.

9. The apparatus of claim 8, wherein an amount of the graphical window interface that is revealed from the edge of the display context is based on a length of the multi-touch gesture.

10. The apparatus of claim 7, wherein the revealed graphical window interface comprises an input interface, the input interface comprising one of an on-screen keyboard and a note-taking application.

11. The apparatus of claim 1, further comprising code that changes a view of contents presented within a graphical window interface in response to the multi-touch gesture, the window event comprising a view event.

12. The apparatus of claim 1, wherein the multi-touch gesture is one of a plurality of multi-touch gestures comprising a gesture library, and wherein each multi-touch gesture of the plurality of multi-touch gestures is assigned to a unique window event.

13. A method comprising:
detecting, by use of a processor, a multi-touch gesture on an information handling device, the information handling device being associated with a plurality of display contexts; and
invoking a window event in response to the multi-touch gesture, the window event being associated with one or more graphical window interfaces presented within a display context of the plurality of display contexts.

14. The method of claim 13, wherein the plurality of display contexts comprises one of:
a plurality of displays associated with the information handling device; and
a plurality of display panes, a display pane comprising a logically defined viewing area within a display associated with the information handling device.

15. The method of claim 13, further comprising assigning a multi-touch gesture to a window event associated with a display context of the plurality of display contexts.

16. The method of claim 13, wherein the window event comprises a repositioning event that moves a graphical window interface from a first display context associated with the information handling device to a second display context associated with the information handling device in response to the multi-touch gesture.

17. The method of claim 13, wherein the window event comprises a revealing event that reveals a graphical window interface on a display context associated with the information handling device in response to the multi-touch gesture.

18. The method of claim 17, wherein the graphical window interface is revealed from an edge of a display context associated with the information handling device.

19. The method of claim 13, wherein the window event comprises a view event that changes a view of contents presented within a graphical window interface in response to the multi-touch gesture.

20. A program product comprising a computer readable storage medium that stores code executable by a processor, the executable code comprising code to perform:
detecting a multi-touch gesture on an information handling device, the information handling device being associated with a plurality of display contexts; and
invoking a window event in response to the multi-touch gesture, the window event being associated with one or more graphical window interfaces presented within a display context of the plurality of display contexts.
